(19) United States
(12) Patent Application Publication
(10) Pub. No.: US 2015/0294267 A1
(43) Pub. Date: Oct. 15, 2015

(54) METHOD AND DEVICE FOR DELIVERING OF TIRE BALANCING WEIGHTS

(71) Applicant: Wegmann automotive GmbH & Co. KG, Veitshochheim (DE)

(72) Inventor: Felix BODE, Veitshochheim (DE)

(21) Appl. No.: 14/249,794

(22) Filed: Apr. 10, 2014

(51) Int. Cl. G06Q 10/08; G06Q 30/06

(52) U.S. Cl. CPC G06Q 10/0875; G06Q 30/0635

(57) ABSTRACT

A method and a device are disclosed for providing and delivering of tire balancing weights and supplies, specifically in wheel and tire workshops. A rack comprises slides bearing trays containing balancing weights and/or other articles. Sensors are provided for detecting the number of trays on the slides. If a slide is detected as empty or a certain number of articles have been taken out of the trays, replacement parts are automatically ordered via a network by generating ordering information and providing these to a supplier. The supplier instructs a manufacturing and delivery site for manufacturing and/or delivering the articles which are then delivered by a delivery service to the workshop.

### BACKGROUND OF THE INVENTION

1. Field of the Invention

The invention relates to a method and a device for delivering tire supplies like balancing weights or valves to workshops, and to provide these supplies to a worker in such a way that they are easily accessible.

2. Description of Relevant Art

In JP 2001/039509, an automated storage and retrieval system as well as a management method thereof is disclosed. Controlling this system requires additional personnel having adequate skills. WO 1993/014463 discloses a method for ordering, shipping and merchandising goods. Here, the goods are stored in attractive floor display. The kind of display is not suitable for goods like balancing weights for vehicle wheels, as these have a comparatively high density resulting in high masses and large weights.

### SUMMARY OF THE INVENTION

The embodiments are based on the object of providing tire supplies and balancing weights to workshops in such a way that a minimum quantity of supplies is always available and can easily be accessed by a worker. Furthermore, operating the system should not require a specific education. Accordingly, it should be possible for an untrained person to operate the system. Furthermore, the system should be suitable for handling and storing small, but comparatively heavy articles like balancing weights for vehicle wheels.

The invention relates to a method and a device for delivering tire supplies like balancing weights or valves as well as other car components, accessories and parts to workshops or (car) plants, and to provide these supplies to a worker/recipient in such a way that they are easily accessible.

In an embodiment, a rack is provided, for example in a workshop—in this document the term workshop also includes a plant—for storing and delivering the supplies.

Preferably, the rack holds a plurality of trays. Instead of the trays, also boxes or containers may be used. For simplicity, herein reference is made to trays, which should include any kind of boxes, containers and any combination thereof for storing small and comparatively heavy articles like balancing weights for vehicle wheels and other supplies like tire valves. It is further preferred, if the rack has at least one slide for holding at least one tray. Preferably, a plurality of trays is stored on a slide. The slides have a front end, which is at least accessible for receiving supplies, and a rear end distant from and opposing to the front end. Preferably, the front end has a lower position than the rear end, which results in a downward slope, which causes a tray to slide to the front end. During normal use, supplies may be manually taken from the tray, which is close to the front end of the slide. If the tray is empty, the tray may be removed from the slide, causing the next tray on the slide for sliding forward to the front end of the tray and provide supplies. Refilling may either be done by pushing a new tray from the front end, and therefore pushing all other trays on the slide backwards to the rear end. In an alternate embodiment, refilling may also be done by inserting a tray at or close to the rear end of a slide. Refilling may also be done by replacing a whole slide by a new slide with filled trays.

Preferably, at least one detector for detecting the presence and/or number of trays is provided. Such a detector may be arranged at each slide. It may be arranged at the front end of a slide for detecting a front most tray. In an alternate embodiment, it may be arranged at the rear end of a slide. It may be a distance sensor measuring the distance from the rear end or any other position. By measuring a distance to the trays, preferably the rearmost tray, the number of trays on a slide may be calculated. In an alternate embodiment, there may be a weight sensor. Such a weight sensor may not only determine the number of trays, it may also give an estimate of the number of items or supplies which are on the trays, preferably in the front most tray. By this way, it may even be determined whether a tray is full, empty, or nearly empty. In another embodiment, there may be an optical sensor like a camera. In the case of a camera, there may be a pattern recognition software which identifies the number of trays and which may even identify the content of the trays. The sensor may be combined with or be part of an identification system. For example, it may be combined with a bar code reader, reading bar codes or similar codes, like QR codes on at least one tray. This code may contain information about the tray and the contents thereof. It may identify the type of supplies as well as the number of pieces contained in a tray. An alternate sensor would be an RFID tag reader reading RFID tags attached to trays. This may prevent false filling of the slides with wrong trays, and it furthermore may help to count the number of pieces and to estimate the required pieces, which may be ordered.

The sensors are coupled to a network for communicating status information. This may be done by a local processor or a local computer, which may for example be a personal computer. The network may be a standard network, like an Ethernet, which may have a connection to the Internet. It may also be a wireless network, like a WLAN or a WAN (Wide Area Network) which may be based on GSM.

The rack may further comprise or be at least associated with a terminal for manually entering information and displaying information. This terminal may be used to indicate the status of the rack. It may further indicate status information from the sensors, which may provide values of the numbers of available trays and/or the contents of the trays, and/or the numbers and types of articles available in the trays and/or rack. Furthermore, the terminal may be used to order specific articles, like specific balancing weight sizes or specific tire valves. It may also be used to order higher quantities than the usual quantities of articles. The terminal may also be a tablet PC or PDA. It may have a touch panel or a key board with an optional mouse or trackball. The terminal may also be connected to a kind of network as described before in conjunction with the sensors. The rack may also have slides and/or means for holding trays, which are not connected or controlled by sensors. This may be useful for articles which are rarely used and which can manually be reordered for example by using the terminal.

The information provided by the sensors and/or the terminal is processed by a computing system, which obtains a status of the rack and its contents and/or the status of a plurality of racks. For example, it may obtain the status of all racks in a larger workshop having a plurality of racks. The data processing system may collect all status information and calculate therefrom an estimate of articles, which will be required in a future time period, like a day, a week, or a month. Of course, any other period of time may be chosen. This estimate and optional other specific orders which have been manually entered via the terminal, are forwarded to a supplier which forwards the information to its processing facility for manufacturing and/or providing the required articles, which then are delivered to the workshop and which can then be stored in the rack, thus refilling the rack.

### BRIEF DESCRIPTION OF THE DRAWINGS

In the following, the invention will be described by way of example, without limitation of the general inventive concept, on examples of embodiment and with reference to the drawings.

FIG. 1 shows a basic diagram of the invention.

FIG. 2 shows a flow diagram of an order process of a workshop.

FIG. 3 shows a flow diagram of an order and delivery process at a supplier.

FIG. 4 shows a flow diagram of a confirmation procedure.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

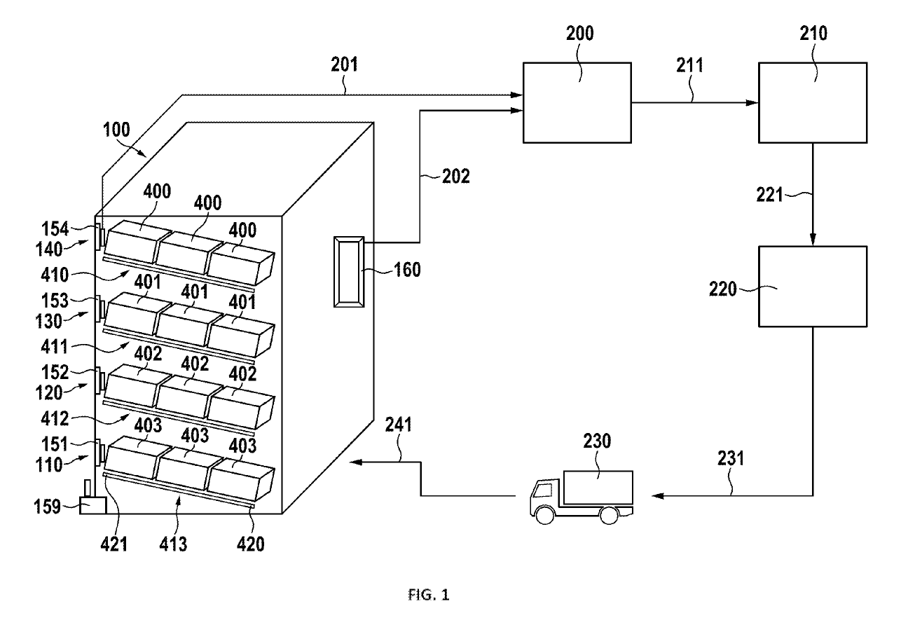

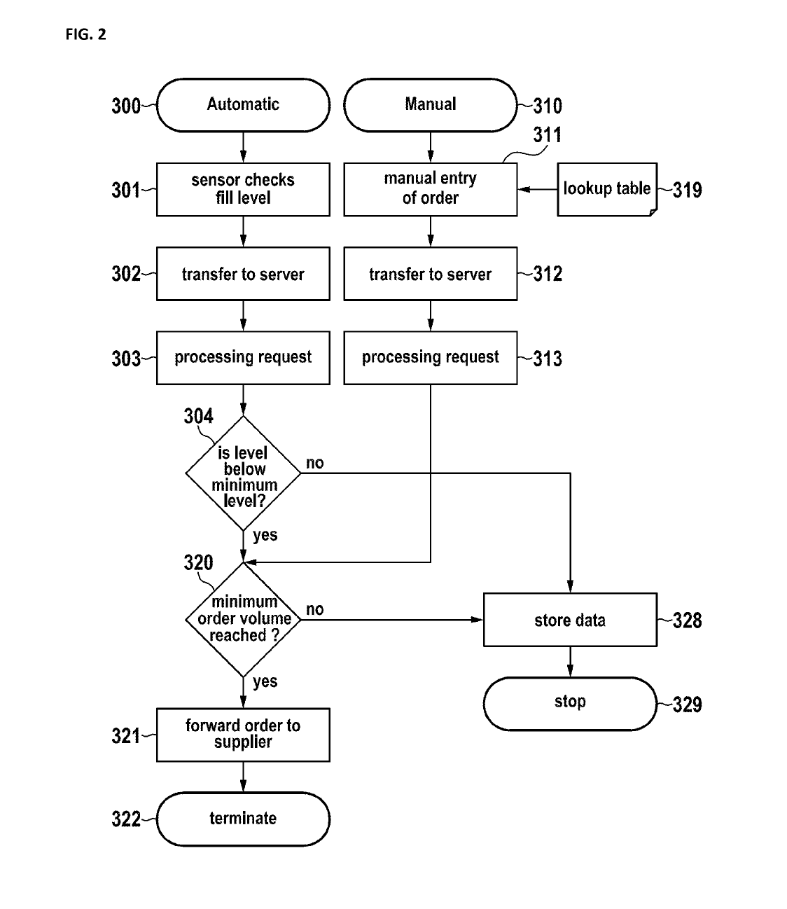

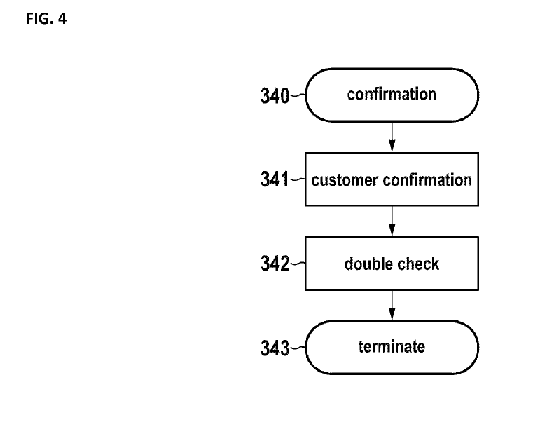

In FIG. 1, a basic diagram of the invention is shown. The FIGS. 2, 3 and 4 show related flow diagrams. A rack 100 has means for holding a plurality of trays 400, 401, 402, 403. The term trays is used herein also for boxes, cartridges and other means for holding smaller articles, like balancing weights, tire valves, or other goods like grease, or tools which are required in a wheel and tire workshop. Preferably, at least a plurality of the trays is held by slides 410, 411, 412, 413. Each slide has a front end 420 and a rear end 421. Preferably, the slide has a slope wherein the rear end is higher than the front end, thus allowing the trays to slide from the rear end to the front end. At the front end, there may be a stop for stopping the trays to fall out of the rack and sliding over the end of the slide. The slides may also have a spring for pushing the trays towards the front end. They also may have a drive like an electrical motor or any other drive means for moving drive means for moving the trays to the front end. Furthermore, sensors 151, 152, 153, 154 are provided for detecting the presence of trays on a slide. The sensors may be optical, magnetic, or mechanical sensors. The sensors may also comprise a bar code reader for reading bar codes attached or printed on the trays. They may also comprise RFID readers for reading RFID tags associated with trays. Reading RFID tags may be also be used for identifying the position of a tray within the rack or within a slide. The rack may also provide locations for storing trays or for storing goods without slides. Furthermore, it is preferred if the rack has a terminal 160 for manually entering information and/or reading information. Such information may be ordering information for additional articles, which are not provided in trays, which are monitored by sensors.

The sensors and/or the terminal may be connected to at least one network. The network may be a wired network and/or a radio network. It furthermore may be connected to the Internet. Information collected by the sensors and/or the terminal is processed by a server 200, which generates orders and/or forecasts. This procedure is shown in more detail in FIG. 2. A start 300 of an automatic ordering procedure may be triggered by a sensor indicating a change of fill level, by a timer, which for example may run once a hour, once a day or once a week, or by a manual input to terminal 160 or any other user action requesting an automatic ordering procedure. In a first step with the level of at least one rack, tray or slide is checked in step 301 by at least one sensor. A fill level may also be determined by storing a fill level value and amending this value, if a sensor indicates a change in fill level. Therefore, the actual fill levels may be read from a memory without further sensor requests. Detected fill levels or other sensor values are transferred in step 302 to a local server 200 (e.g., via a transmitter, such as, for example, an I/O device of the sensor itself or a multiplexer or hub that is connected to one or more of the sensors via a wired connection to, or network transceiver or network interface controller (NIC), network interface card, LAN adapter, and/or any other device configured to transmit a detection or data detected by at least one sensor to the local server via a wired or wireless connection). This local server may also be integrated into the terminal 160. Besides the automatic ordering procedure, there may be a manual ordering procedure 310. In step 311 an order is manually entered into the terminal 160. Entering may be assisted by a lookup table 319 supplying additional information like part number and/or prices. This lookup table may be provided electronically either in terminal 160 or readable by a separate personal computer or as a printed paper. In step 312 the manually entered data is transferred to the server 200. It is further preferred, if a manual ordering process also triggers an automatic ordering process. A manual ordering process is preferred for goods and articles which are not checked by sensors and therefore supplements an automatic ordering process. The provided information in the automatic ordering request is processed in step 303, while the information in the manual ordering request is processed in step 313. When processing the automated request, in step 304 it is checked, whether the level is below a minimum threshold level. If the level is still above a minimum level, the information or data is stored in step 328 and the procedure is stopped 329. Otherwise, when the level is below the minimum level, it is further checked in step 320, whether a minimum order volume has been reached. This check is also performed with all manually entered orders. If this minimum order volume has not been reached, data is further stored in step 328 and processing is stopped 329. For the case, the minimum order volume has been reached, an order is forwarded 211 to a manufacturer or supplier 210 in step 321 (e.g., to a local server or computer of the manufacturer or supplier 210 via a wired or wireless network). This terminates 322 local processing at the workshop.

The orders and/or forecasts may also be generated based on the number of actually used trays and/or articles. This is preferably done in the server 200. In an alternate embodiment, simply a new tray of articles may be ordered if there is only one tray remaining in the rack. Of course, ordering may be done depending on any other number of remaining trays. For example, another three trays may be ordered if there are still two trays remaining in the rack.

Preferably, the orders may be based on the actual consumption of articles and/or trays, based on information 201 received by the sensors, and/or information 202 received by the terminal. The ordering information 211 generated thereby is provided to a supplier 210 which forwards the collected information as a manufacturing information 221 to a manufacturing and delivery site 220 (e.g., to a local server or computer of the manufacturing and delivery site 220 via a wired or wireless network). Here, the required articles are manufactured or at least provided to be delivered by delivery 231 to a delivery service 230, transporting 241 the articles to the workshop, where they can be placed into the rack.

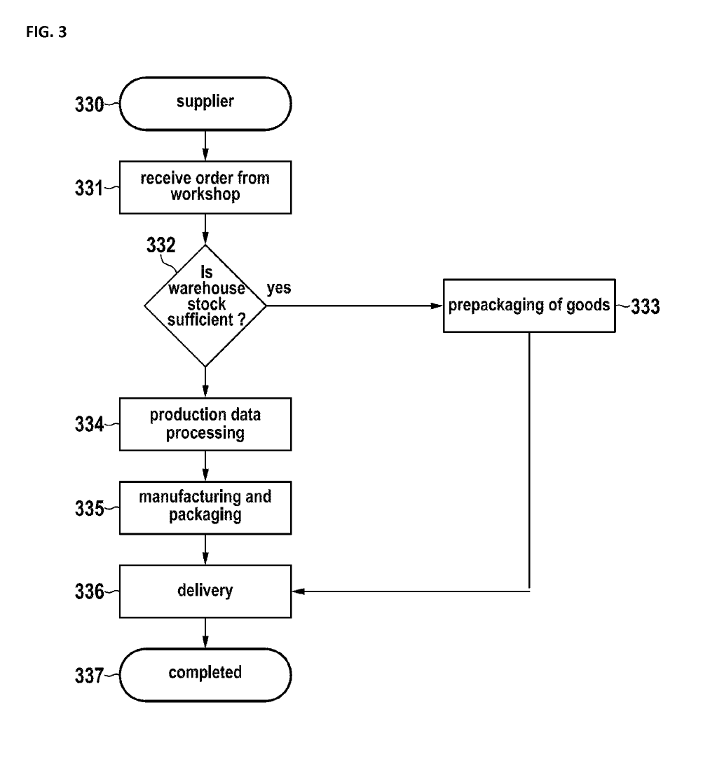

The process flow at the manufacturer or supplier is shown in more detail in FIG. 3. Processing at the supplier starts in 330. First, the order transmitted by the workshop in step 321 is received in step 331 by the supplier. Then in step 332 it is checked, whether the warehouse stock is sufficient. If it is sufficient, pre-packing of goods is done in step 333. If it is not sufficient, a production process is started by processing of production data in step 334 and manufacturing and packaging of the goods in step 335. In step 336 the goods of steps 335 and/or 333 are delivered to the workshop. Then the supplying process is completed 337. This may further be complimented by a confirmation procedure starting in step 340 and ending in 343. There may be a customer confirmation step 341. This confirmation may be done by manually entering confirmation data into terminal 160 and/or by reading sensor values indicating that at least one rack and/or slide and/or tray has been refilled. Furthermore, there may be a double check 342 which may be done by considering the total inventory.

It will be appreciated to those skilled in the art having the benefit of this disclosure that this invention is believed to provide a method and device for delivering of tire supplies and balancing weights. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 rack
151, 152, 153, 154 sensors
160 terminal
200 server
201 information received by the sensors
202 information received by the terminal
210 supplier
211 ordering information
220 manufacturing and delivery site
221 manufacturing information
230 delivery service
231 delivery
241 transporting the articles
300 start of automatic ordering procedure
301 sensor checks fill level of tray
302 transfer of data to a local server
303 processing of request at local server
304 check if fill level is below minimum level
310 start of manual ordering procedure
312 transfer of data to a local server
313 processing of request at local server
319 information is supplied by lookup table
320 check if minimum order volume is reached
321 forward order to manufacturer
322 terminate local ordering process
328 store data at local server
329 stop local processing
330 supplier-based procedure
331 receive order from workshop
332 check if warehouse stock is sufficient
333 pre-packing of goods
334 production data processing
335 manufacturing and packaging
336 delivery of goods
337 order completed
340 confirmation
341 customer confirmation
342 plausibility check
400, 401, 402, 403 trays
410, 411, 412, 413 slides
420 front end
421 rear end

1. A method for delivering tire balancing weights and car supplies, the method comprising:
collecting with at least one sensor information about trays containing articles, the trays within a rack in a tire and wheel workshop or plant, the articles including at least balancing weights and supplies;
receiving the information at a data processing system configured to generate forecasts and/or orders on specific quantities of articles in a specific time frame;
forwarding one or more orders from the data processing system to a supplier system;
receiving orders at a manufacturing and storage site via the supplier system;
manufacturing and/or providing the required articles;
delivering the required articles to the workshop or plant.

2. The method according to claim 1, wherein additional information is provided by a terminal into which orders are entered manually.

3. The method according to claim 1, wherein the information is transmitted via a network.

3. The method according to claim 1, wherein the one or more orders are forwarded via the Internet.

4. The method according to claim 1, further comprising:
comparing with the data processing system the information to a first threshold under which additional articles should be ordered; and
generating an order if the information indicates a number of articles below the first threshold.

5. The method according to claim 4, further comprising:
determining with the data processing system whether the one or more orders exceed a second threshold under which orders should not be transmitted; and
forwarding the one or more orders if the one or more orders exceeds the second threshold.

6. A rack for storing tire balancing weights and car supplies, the rack comprising:
at least one slide for holding a plurality of trays containing balancing weights and/or supplies;
at least one sensor each assigned to a slide and configured to detect the presence and/or number of trays on the slide; and
a transmitter configured to communicate information detected by the sensor to a server for generating orders to refill the rack.

7. The rack according to claim 6, further comprising a terminal configured to permit a user to manually enter orders.

8. The rack according to claim 6, wherein at least one of the sensors is connected to a network.

9. The rack according to claim 6, wherein the terminal is connected to a network.

10. The rack according to claim 6, wherein at least one of a sensor and the terminal is connected to a wireless network.

11. A system for ordering tire balancing weights and car supplies, the system comprising:
a rack disposed in a tire and wheel shop, the rack comprising:
at least one slide for holding a plurality of trays containing articles that include at least balancing weights and supplies;
at least one sensor each assigned to a slide and configured to detect the presence and/or number of trays on the slide; and
a transmitter configured to communicate information detected by the sensor;
a data processing system in communication with the transmitter to receive the detected information, and configured to generate forecasts and/or orders on specific quantities of articles in a specific time frame, and to transmit the orders;
a supplier computer system remote from the tire and wheel shop, the supplier computer system configured to receive an order from the data processing system and forward the order to a manufacturing and storage site;
a manufacturing and storage site having a computer configured to receive the order from the supplier computer system and determine whether the articles are in stock or need to be manufactured.

12. The system according to claim 11, wherein the rack further comprises a terminal configured to permit a user to manually enter orders.

13. The system according to claim 11, wherein the data processing system is in communication with the transmitter via a network.

14. The system according to claim 11, wherein the data processing system is in communication with the transmitter via the Internet.

15. The system according to claim 11, where the data processing system is further configured to:
compare the information to a first threshold under which additional articles should be ordered; and
generate an order if the information indicates a number of articles below the first threshold.

16. The system according to claim 15, where the data processing system is further configured to:
determine whether the size of one or more orders exceeds a second threshold under which orders should not be forwarded; and
forward the one or more orders to the supplier computer system if size of the one or more orders exceed the second threshold.
